(19) United States
(12) Patent Application Publication
(10) Pub. No.: US 2026/0094500 A1
(43) Pub. Date: Apr. 2, 2026

(54) GAMING MACHINE AND METHOD INCLUDING AN ACCUMULATOR-BASED VALUE TRANSFER BONUS

(71) Applicant: LNW Gaming, Inc., Las Vegas, NV (US)

(72) Inventors: Joel R. JAFFE, Glenview, IL (US); Brent William DANIELS, Brooklyn, NY (US)

(21) Appl. No.: 19/293,560

(22) Filed: Aug. 7, 2025

Related U.S. Application Data
(60) Provisional application No. 63/702,206, filed on Oct. 2, 2024.

(51) Int. Cl. G07F 17/32

(52) U.S. Cl. CPC G07F 17/3244; G07F 17/3213

(57) ABSTRACT

Disclosed are a gaming machine and method for implementing a bonus game including an accumulator and two types of overlay symbols. The overlay symbols, one value-bearing and the other not, are superimposed onto an array of cells, each cell including a symbol-bearing reel. During a series of bonus spins, the overlay symbols are repositioned, potentially shifting out of the array. If a value-bearing overlay symbol exits the array, its value is added to the accumulator. The core interaction of this bonus occurs when a reel symbol lands in a cell occupied by one of the overlay symbols. If the overlay symbol is a value-bearing overlay symbol, its value transfers to the newly landed symbol. If the overlay symbol does not bear a value, the current value of the accumulator transfers to the newly landed symbol. At bonus game end, a prize based on all of the transferred values is awarded.

### CROSS-REFERENCE TO RELATED APPLICATIONS

This patent application claims priority benefit of U.S. Provisional Ser. No. 63/702,206 filed Oct. 2, 2024. The disclosure of the 63/702,206 Application is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024-2025, LNW Gaming, Inc.

### FIELD OF THE INVENTION

The present invention relates to a technological improvement to gaming systems, gaming machines, and methods and, more particularly, to technological improvements in connection with a bonus feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus enhancements with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

Disclosed are a gaming machine and method for implementing a bonus game including an accumulator and two types of overlay symbols. The overlay symbols, one value-bearing and the other not, are superimposed onto an array of cells, each cell including a symbol-bearing reel. During a series of bonus spins, the overlay symbols are repositioned, potentially shifting out of the array. If a value-bearing overlay symbol exits the array, its value is added to the accumulator. The core interaction of this bonus occurs when a reel symbol lands in a cell occupied by one of the overlay symbols. If the overlay symbol is a value-bearing overlay symbol, its value transfers to the newly landed symbol. If the overlay symbol does not bear a value, the current value of the accumulator transfers to the newly landed symbol. At bonus game end, a prize based on all of the transferred values is awarded.

In accordance with one or more embodiments, a method and a gaming machine configured to execute a method of conducting a wagering game includes the steps of displaying a symbol array comprising a plurality of cells, each cell comprising a reel and initialized to an unlocked state. The method further includes the steps of displaying an accumulator, initializing a spin counter, and placing a plurality of overlay symbols in unlocked cells in the symbol array. The overlay symbols include at least a first type of overlay symbol that bears a value and a second type of overlay symbol that does not bear a value. The method continues for a plurality of game cycles. During each game cycle, for each respective unlocked cell in the symbol array, the method includes the steps of: (1) spinning and stopping its reel to newly land a symbol in the respective unlocked cell; (2) in response to an overlay symbol of the first type and a newly landed symbol being co-located, transferring the value borne by the first type of overlay symbol to the newly landed symbol, removing the overlay symbol, and locking the respective cell; (3) in response to an overlay symbol of the second type and a newly landed symbol being co-located, removing the overlay symbol, transferring the value of the accumulator to the newly landed symbol and locking the respective cell; (4) repositioning any remaining overlay symbols in the symbol array, wherein repositioning each respective overlay symbol comprises moving the overlay symbol in a predetermined direction to the next unlocked cell in the symbol array or removing the overlay symbol from the symbol array in the event there is no unoccupied cell in the predetermined direction; (5) in response to at least one first type of overlay symbol being removed from the symbol array, adjusting a value of the accumulator; (6) adding new overlay symbols to unlocked cells in the symbol array; and (7) decrementing the spin counter. The bonus game ends in response to the spin counter reaching zero or all positions in the symbol array being occupied by locked symbols, whereupon a prize based on the transferred values is awarded.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3A-3D combine into a flow diagram for a data processing method that corresponds to instructions executed by a controller according to an embodiment of the present invention. FIG. 3A relates to a base-game portion of a wagering game; FIG. 3B relates to execution of a bonus game; FIG. 3C relates to pre-spin activity of the bonus game of FIG. 3B;

FIG. 3D relates to post-spin activity of the bonus game of FIG. 3B.

FIG. 4 is an exemplary presentation of a base-game spin outcome in accordance with one or more embodiments.

FIG. 5 is an exemplary presentation of a bonus game spin outcome in accordance with one or more embodiments.

FIG. 6 illustrates various bonus game symbols in accordance with one or more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation. ”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

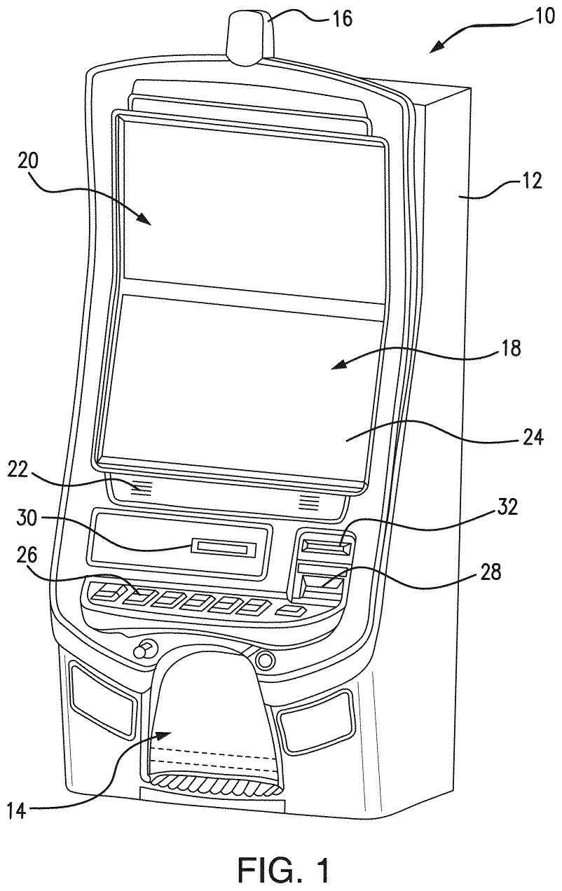

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 includes a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices, which together provide a graphical user interface, are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry 40 for processing. The electronic data signals are selected from a group consisting essentially of an electrical current, an electrical voltage, an electrical charge, an optical signal, an optical element, a magnetic signal, and a magnetic element.

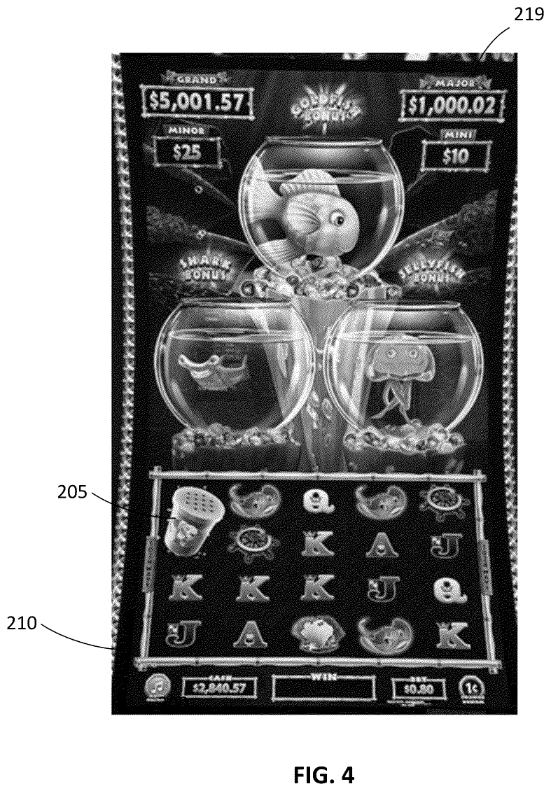

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

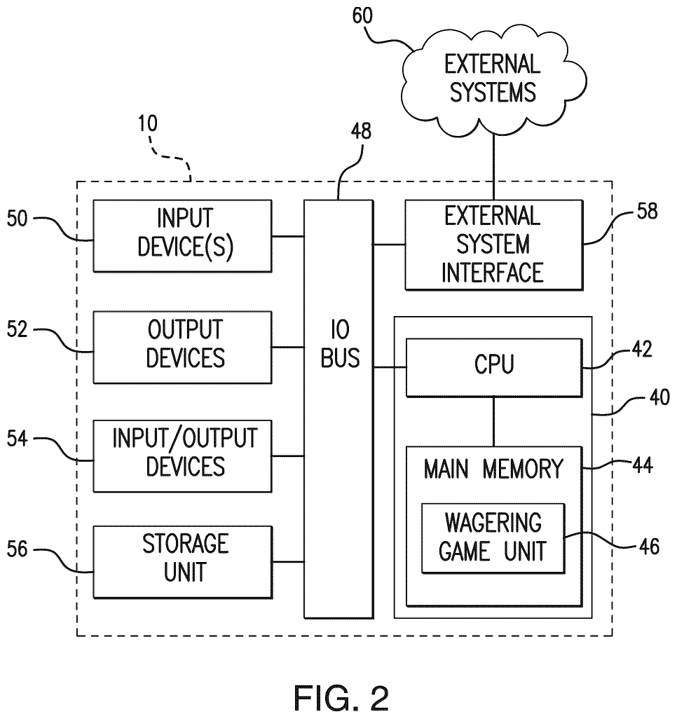

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that includes one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, includes any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, includes one or more controllers or processors and such one or more controllers or processors need not be disposed proximal to one another and may be located in different devices or in different locations. The game-logic circuitry 40, and more specifically the main memory 44, includes one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 includes a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry 40 facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method includes the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media includes storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device includes a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts includes acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

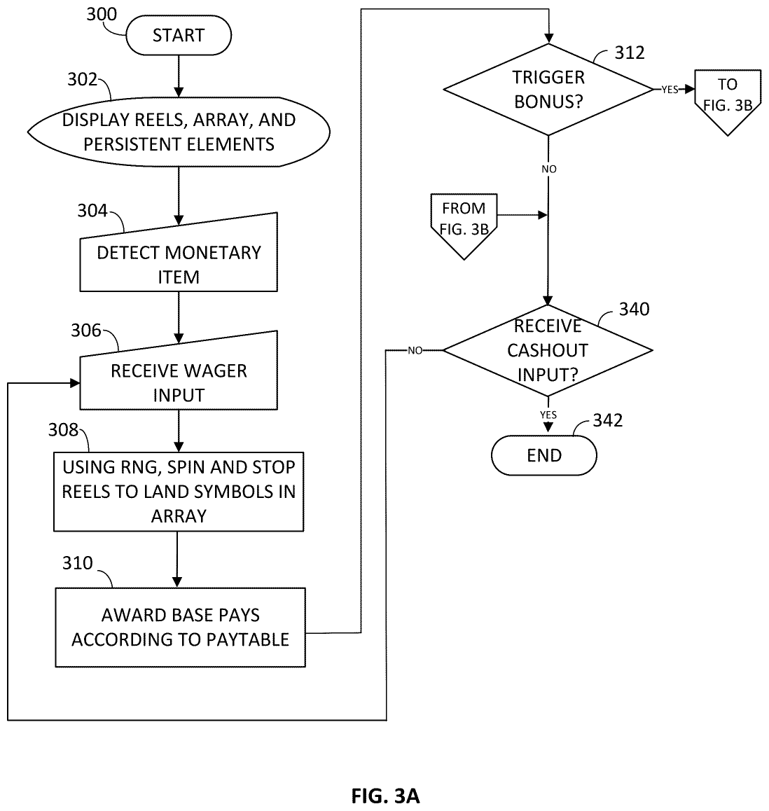

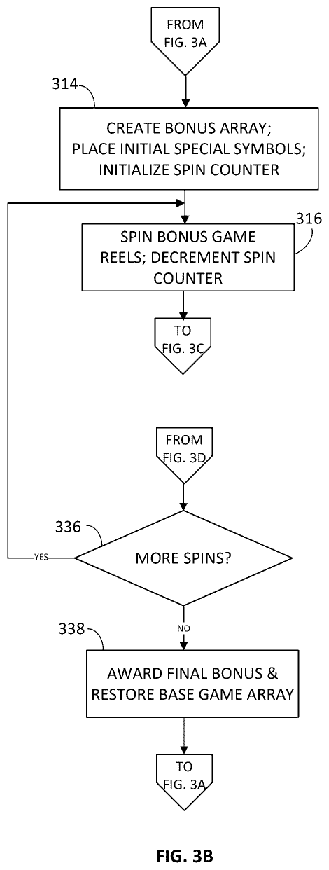

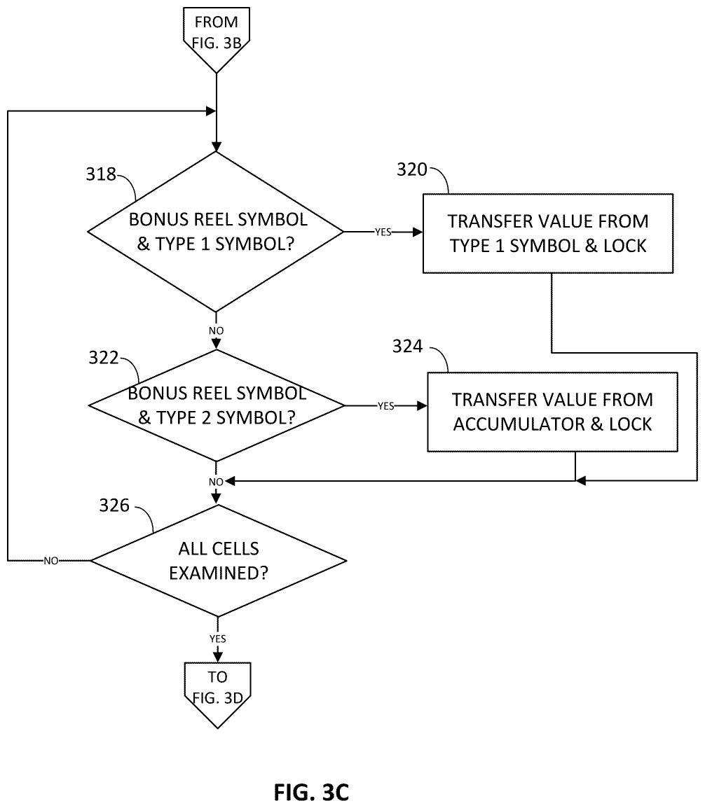

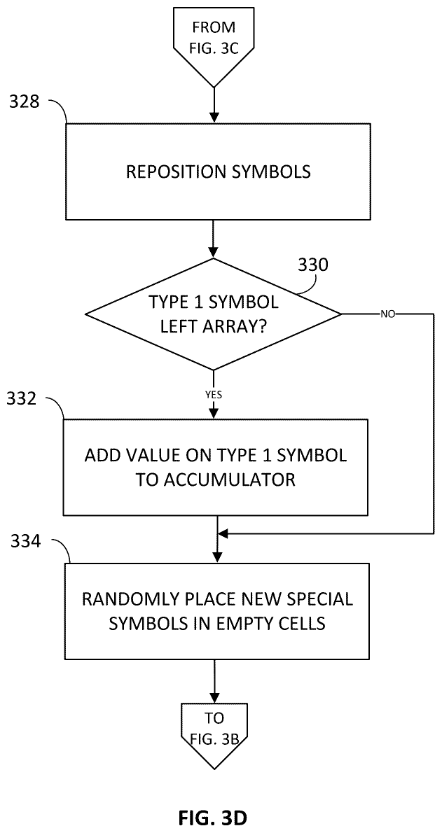

Referring now to FIGS. 3A-3D, there is shown a flow diagram representing one data processing method 300 corresponding to at least some instructions stored and executed by the game-logic circuitry 40 in FIG. 2 to perform operations according to an embodiment of the present invention.

### Game Play Initiation

Referring to FIG. 3A, the data processing method commences at step 300.

At step 302, the game-logic circuitry 40 controls one or more presentation devices 18, 20 (e.g., mechanical-reel display device, video display device, or a combination thereof) of the graphical user interface to present a plurality of symbol-bearing reels and a base game array of symbol positions or “cells.” Although the method is described with respect to one presentation device, it is to be understood that the presentation described herein may be performed by a presentation assembly including more than one presentation device.

The array may be arranged in a variety of configurations, formats, or structures and may include a plurality of rows and columns, the intersection of which form cells. The rows of the array are oriented in a generally horizontal direction, and the columns of the array are oriented in a generally vertical direction. The cells in each row of the array are horizontally aligned with each other, and the cells in each column of the array are vertically aligned with each other. Alternatively, the cells may be arranged in a honeycomb configuration with adjacent columns vertically offset from each other by one-half cell or adjacent rows horizontally offset from each other by one-half cell. The number of cells in different rows and/or different columns may vary from each other.

The reels bear a plurality of symbols that include various base game symbols and, in some embodiments, a WILD symbol that can substitute for any of the base game symbols. From play to play of the base game (a base game cycle), the reels spin and stop in response to a wager. When the reels are spun, either mechanically or in an animated fashion on a video display device, they come to a stop to “land” or “display” one or more of the symbols they bear in the cells of the symbol array. This process may be known as “populating” the symbol array. Once “landed,” a symbol may be said to be “in,” “at,” “located in,” “located at,” or to “occupy” a cell. The reels may bear a combination of symbols and blank spaces (“blanks”) such that when a given reel stops spinning, some of the cells associated with that reel need not be occupied by a symbol.

The reels may be associated with the respective columns of the array such that the reels spin vertically, and each reel populates a respective column. In another embodiment, the reels may be associated with the respective rows of the array such that the reels spin horizontally, and each reel populates a respective row. In some embodiments, the reels are associated with respective individual cells of the array such that each reel animates in place and populates only its respective cell. In some embodiments, the cells of the symbol array may be populated without spinning reels. For example, some or all of the symbols populating the array may simply be displayed in their respective cells.

In some situations, a cell may be occupied by more than one symbol. For example, the symbol array may be populated with symbols by the reels, then additional symbols may be superimposed or “stacked” on or in the cells along with the newly landed symbols. In some cases, the additional symbols are simply displayed in their respective cells. In other embodiments, each cell may have an associated “overlay reel” bearing semitransparent symbols. These overlay reels spin much like the normal reels, potentially leading to an overlay symbol being superimposed on, over or in front of a normal reel symbol. In other embodiments, some of the symbols may be sized or positioned so that they do not take up the entire space in the cell. In these embodiments, multiple symbols in a given cell may appear adjacent to one another. When two or more symbols occupy the same cell, they are said to be “co-located” or “co-located symbols.”

FIG. 4 illustrates an example of the display at the conclusion of a representative base-game spin. In this example, the base-game array 210 has a four-by-five rectangular configuration including twenty cells, and each cell includes a respective independent reel. The reels also bear a plurality of various visually distinct base game symbols.

Returning now to FIG. 3A, at step 304, the game-logic circuitry 40 detects, via a value input device, a physical item associated with a monetary value that establishes a monetary balance in the form of cash or credits. The monetary balance may be shown on a credit meter.

### Base Game Spin

At step 306, the game-logic circuitry 40 initiates a base game cycle (i.e., spin cycle) in response to an input indicative of a wager covered by the monetary balance. To initiate a spin of the reels, the player may press a “Spin” or “Max Bet” key on a button panel or touch screen.

At step 308, using an RNG, the game-logic circuitry 40 spins and stops the reels to randomly land symbols from the reels in the array in visual association with one or more paylines (also known as lines, ways, patterns, or arrangements). The reel spin may be animated on a video display by depicting symbol-bearing strips moving vertically across the display and synchronously updating the symbols visible on each strip as the strip moves across the display. Alternatively, the reels may be physical/electromechanical reels.

### Base Game Win Evaluation

At step 310, once the reels have stopped spinning, the symbols populating the array are evaluated by the game-logic circuitry 40. Payouts are awarded in accordance with a pay table. The pay table may, for example, include “line pays,” “ways pays” and “scatter pays.” Line pays occur when a predetermined type and number of symbols appear along an activated payline, typically in a particular order such as left to right, right to left, top to bottom, bottom to top, etc. Ways pays appear on adjacent reels without the requirement to be on a specified pay line or directly adjacent to one another. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. To animate a standard pay, the display may apply a border, pattern, color change, background change, watermark, or other distinguishing characteristic to the winning payline and/or winning symbols that contributed to the pay.

At step 312, once basic pays have been paid according to the pay table, the game-logic circuitry 40 randomly determines, via the RNG, whether or not to trigger a bonus game. In some embodiments, the bonus game may also be triggered in response to a particular event or base game spin outcome. For example, when a fish food shaker 205 lands in a cell of the base game array 210, a bonus game may be triggered.

If a bonus game is not triggered at step 312, the game-logic circuitry 40 proceeds to step 340 to complete the current base game cycle. If, however, a bonus game is triggered at step 312, the game-logic circuitry 40 instead proceeds to step 314 of FIG. 3B.

### Bonus Game Initiation

At step 314, a bonus array is created to replace the base game array on the display. The bonus array may take any of the forms described above and may have the same configuration as the base game array or may have a different configuration than the base game array.

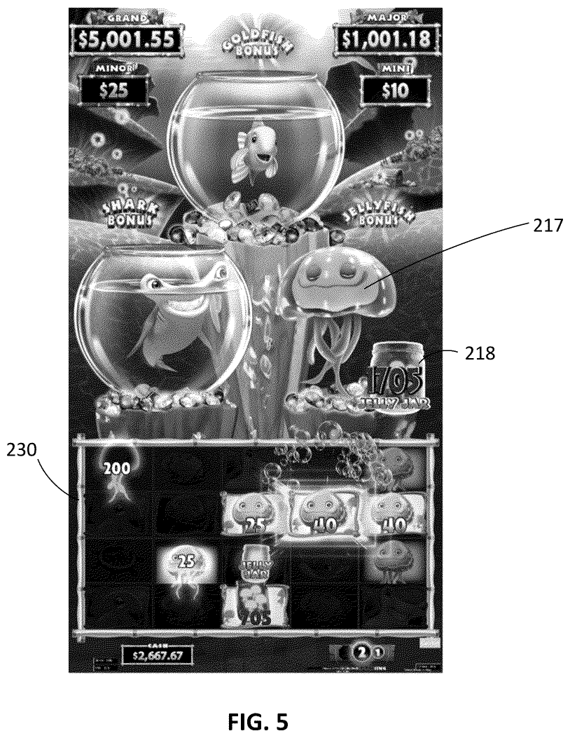

In addition, bonus reels are generated. The bonus reels may take any of the forms described above and may bear the same symbols, different symbols or any combination thereof. In the example of FIG. 5, the bonus array 230 has the same configuration as the base game array 210 and each bonus reel is associated with a cell of the bonus array 230. Thus, in the 4×5 bonus array 230, there are 20 individual bonus reels. The bonus reels bear a mix of bonus reel symbols and blanks.

Two types of special symbols—capable of being co-located in a cell with a bonus reel symbol such that both the bonus reel symbol and the special symbol can be identified—are also employed in the bonus game.

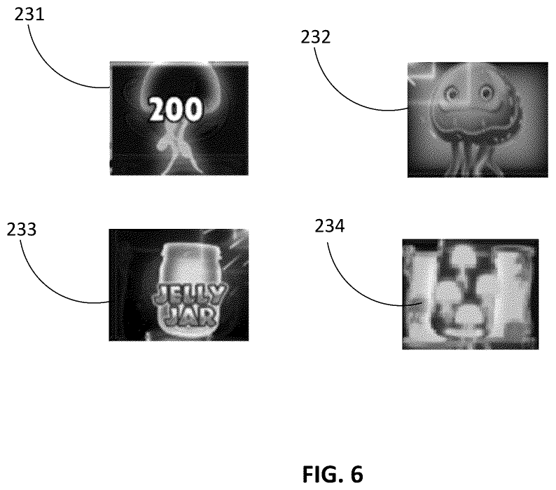

A Type 1 symbol 231 (FIG. 6) is an overlay symbol that bears a value. The value borne by a given Type 1 symbol 231 may be a monetary or credit amount or a progressive award label 219 (FIG. 4). GRAND, MAJOR, MINOR and MINI are representative examples of progressive award labels. Such value-bearing symbols are commonly known as WYSIWYG (“What You See Is What You Get”) or “cash on reels” symbols.

A Type 2 symbol 233 (FIG. 6) is an overlay symbol that does not bear a value, but functions as described below. Type 1 symbols 231 and Type 2 symbols 233 need not be overlay symbols, provided they can be co-located with a bonus reel symbol in a cell.

To aid in the interpretation of FIG. 5, which illustrates the results of a bonus game outcome in accordance with one or more embodiments, FIG. 6 correlates examples of visually distinct symbols with respective symbol types. In the examples of FIG. 5 and FIG. 6, a “Ghost Jellyfish” is associated with a Type 1 symbol 231. A “Jellyfish” is associated with a bonus game symbol 232. A “Ghost Jelly Jar” is associated with a Type 2 symbol 233 and a “Modified Jellyfish” is associated with an enhanced bonus reel symbol 234. These are examples only. Any visually distinct symbol may be associated with a particular symbol type.

At step 314, a random number of Type 1 symbols 231 and Type 2 symbols 233 are placed in randomly selected cells in an otherwise empty bonus array 230. These symbols may be animated to float up from beneath the bonus array 230 into their positions.

An accumulator 218 is also displayed at this step. The accumulator 218 bears a value and is initialized to a random or predetermined value, including zero. In the example of FIG. 5, the accumulator bears a value of 1705 credits.

Also at step 314, a spin counter is initialized to a starting value, for example, to 3.

At step 316, the bonus reels are spun to land symbols from the bonus reels in the bonus array 230 in the manner described above with respect to step 308. The spin counter is decremented, for example, from 3 to 2. Flow then proceeds to step 318 of FIG. 3C.

At step 318, in the event a newly landed bonus reel symbol 232 appears behind (or otherwise co-located with) a Type 1 symbol 231, the value born by the Type 1 symbol 231 is transferred to the underlaying (or co-located) bonus reel symbol 232 at step 320. The Type 1 symbol 231 is then removed from the bonus array 230 and the cell is locked. The spin counter may also be reset, for example, to 3.

At step 322, in the event a newly landed bonus reel symbol 232 appears behind (or otherwise co-located with) a Type 2 symbol 233, the Type 2 symbol is removed from the bonus array 230 and the current value of the accumulator 218 is transferred to the previously co-located bonus reel symbol 232 at step 324. The cell is locked. The spin counter may be reset, for example, to 3.

Any newly landed bonus reel symbol 232 not overlaid by a Type 1 symbol 231 or a Type 2 symbol 233 is ignored. The cell is not locked and the bonus reel associated with this cell will re-spin during the next bonus game spin cycle. The spin counter is not reset.

At step 326, if there is another cell to be evaluated, flow returns to step 318, otherwise flow continues at step 328 of FIG. 3D.

At step 328, Type 1 symbols 231 and Type 2 symbols 233 in the bonus array 230 are repositioned. These overlay symbols may be animated to “float” up one or more rows to the next unoccupied cell, skipping over locked cells. If no more empty cells are available in a particular column, a Type 1 symbol 231 or a Type 2 symbol 233 may shift out the top of the bonus array 230 and be removed.

In some embodiments, the direction of repositioning may vary, for example, the Type 1 symbols 231 and the Type 2 symbols 233 symbols may move right, left or down instead of up.

At step 330, in the event a Type 1 symbol 231 is repositioned out of the bonus array 230, its value is added to the accumulator 218 at step 332, otherwise flow skips to step 334.

Depending on the embodiment, in the event a Type 1 symbol 231 shifting out of the bonus array 230 bears a jackpot identifier 219, the accumulator 218 may or may not be incremented by the current value of the identified jackpot.

At step 334, after all of the Type 1 symbols 231 and Type 2 symbols 233 in the bonus array 230 have been repositioned, a random number of new Type 1 symbols 231 and Type 2 symbols 233 may be placed in randomly selected unoccupied cells in the bonus array 230. An animation may accompany these placements. For example, the new symbols may be animated to float up from beneath the bonus array 230 into their selected positions. At the conclusion of step 334, the flow then returns to step 336 of FIG. 3B.

At step 336, the game-logic circuitry 40 checks to see if any bonus game spins remain. The bonus game can terminate in two ways. If all positions in the bonus array 230 contain locked symbols, the bonus game ends. Otherwise, if the spin counter reaches zero, for example, if three spins in a row with no newly locked symbols occur, the bonus game also ends.

In the event that spins remain, flow returns to step 316 for another bonus game spin cycle, otherwise, flow continues at step 340.

At step 340, a final evaluation of the bonus array is performed and any additional prizes are determined and awarded. The bonus array is removed and the base game array is restored. Flow continues at step 342 of FIG. 3A, where a new base-game cycle will be initiated at step 306 if a new wager is to be made, otherwise the method ends at step 344.

FIG. 5 illustrates examples of several of the above aspects in accordance with one or more embodiments.

First, two bonus reel symbols 232 (Jellyfish) bearing 25 and 40 credits, respectively, are locked in the third and fifth columns of the bonus array 230 from a previous spin.

Second, a newly landed bonus reel symbol 232 (Jellyfish) in the fourth column has just been assigned a value of 40 credits.

Third, another newly landed bonus reel symbol 232 (Jellyfish) and a co-located Type 1 symbol 231 (Ghost Jellyfish) is positioned in a cell in the second column of the bonus array 230 and is waiting to be processed.

Fourth, a bonus reel symbol 232 symbol (Jellyfish) bearing 705 credits is locked in the bottom row, a recipient of matchup with a Type 2 symbol 233 (Ghost Jelly Jar) on a previous spin. The original bonus reel symbol 232 symbol (Jellyfish) in this cell has been replaced by an enhanced bonus reel symbol 234 (Modified Jellyfish) to signify that this cell had a value from the accumulator 218 applied to it. The enhanced bonus reel symbol 234 bears a value of 705 credits, which was the value of the accumulator 218 at the time the cell was locked. Note that the value of the accumulator 218 has advanced since then as other Type 1 symbols 231 (Ghost Jellyfish) were repositioned out of the bonus array and their values were added to the accumulator 218.

Fifth, a Type 1 symbol 231 (Ghost Jellyfish) without a co-located bonus reel symbol 232 (Jellyfish) is in the top row of the bonus array and will be repositioned out of the bonus array 230 at the start of the next spin. Its value will be added to the accumulator 218 at that time.

Finally, a Type 2 symbol 233 (Ghost Jelly Jar) without a co-located bonus reel symbol 232 (Jellyfish) is in the middle column of the bonus array 230. It will be repositioned to the top row at the start of the next spin, skipping over the locked value-bearing bonus reel symbol 232 (Jellyfish) symbol in the second row.

In this description, numerous specific details are set forth. However, it is understood that embodiments of the invention may be practiced without these specific details. Variations falling within the scope of the invention may include a spin counter that counts up rather than down. While presented as a standalone bonus game, the above principles may operate in conjunction with other bonuses or bonus enhancements during a bonus game.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

Some embodiments of the present invention include an innovative application of data processing steps that, when implemented by game-logic circuitry 40, direct a presentation assembly of the graphical user interface to present a symbol-value collection and award process that minimizes processing overhead by utilizing WYSIWYG symbols instead of complex, fanciful game images. In this way, the value-bearing symbols require fewer rules needed for the award process than would be necessary for calculating values of winning symbol combinations enumerated in stored pay tables, as found in more complex reel-spinning routines. At the same time, embodiments of the present invention provide a straightforward, WYSIWYG visual presentation that is simple to understand and, therefore, effective in generating player excitement and enthusiasm. The result is a highly flexible value-award process that can be easily adapted to any theme/brand while remaining easily understood by players.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of conducting a wagering game, the method comprising:
displaying a symbol array comprising a plurality of cells, each cell comprising a reel, each cell of the symbol array initialized to an unlocked state;
initializing a spin counter;
placing a plurality of overlay symbols in unlocked cells in the symbol array, wherein the overlay symbols comprise at least a first type of overlay symbol that bears a value and a second type of overlay symbol that does not bear a value;
providing an accumulator that displays an aggregated value associated with one or more of the overlay symbols;
for a plurality of game cycles:
for each respective unlocked cell in the symbol array:
spinning and stopping its reel to newly land a symbol in the respective unlocked cell;
in response to an overlay symbol of the first type and a newly landed symbol being co-located, transferring the value borne by the first type of overlay symbol to the newly landed symbol, removing the overlay symbol, and locking the respective cell;
in response to an overlay symbol of the second type and a newly landed symbol being co-located, removing the overlay symbol, transferring the value of the accumulator to the newly landed symbol and locking the respective cell;
repositioning any remaining overlay symbols in the symbol array, wherein repositioning each respective overlay symbol comprises moving the overlay symbol in a predetermined direction to the next unlocked cell in the symbol array or removing the overlay symbol from the symbol array in the event there is no unoccupied cell in the predetermined direction;
in response to at least one first type of overlay symbol being removed from the symbol array, adjusting a value of the accumulator;
adding new overlay symbols to unlocked cells in the symbol array;
decrementing the spin counter; and
in response to the spin counter reaching zero or all positions in the symbol array being occupied by locked symbols, ending the game and awarding a prize.

2. The method of claim 1, wherein the symbol array is initially empty.

3. The method of claim 1, wherein the overlay symbols are semi-transparent.

4. The method of claim 1, wherein placing the overlay symbols and adding new overlay symbols comprises randomly displaying the overlay symbols in unlocked cells of the symbol array.

5. The method of claim 1, further comprising resetting the spin counter in response to a symbol and an overlay symbol being co-located.

6. The method of claim 1, wherein the value borne by at least one of the first type of overlay symbols is selected from the group consisting of a monetary amount, a credit amount, and a progressive award label.

7. The method of claim 1, wherein the value of the accumulator is initialized to a random value.

8. The method of claim 1, wherein adjusting the value of the accumulator comprises incrementing the value of the accumulator by the value borne by the at least one first type of overlay symbol being removed from the symbol array.

9. The method of claim 1, wherein repositioning each respective overlay symbol further comprises skipping over locked cells.

10. The method of claim 1, wherein the newly landed symbol is modified to a visually distinct enhanced symbol in response to the value of the accumulator being transferred to the newly landed symbol.

11. A gaming machine comprising:
a presentation assembly;
a value input device configured to accept a physical item associated with a monetary value to establish a credit balance;
a value output device configured to dispense a payout from the credit balance in response to a cashout input; and
game-logic circuitry configured to perform the operations of:
displaying a symbol array comprising a plurality of cells, each cell comprising a reel, each cell of the symbol array initialized to an unlocked state;
displaying an accumulator;
initializing a spin counter;
placing a plurality of overlay symbols in unlocked cells in the symbol array, wherein the overlay symbols comprise at least a first type of overlay symbol that bears a value and a second type of overlay symbol that does not bear a value;
for a plurality of game cycles:
for each respective unlocked cell in the symbol array:
spinning and stopping its reel to newly land a symbol in the respective unlocked cell;
in response to an overlay symbol of the first type and a newly landed symbol being co-located, transferring the value borne by the first type of overlay symbol to the newly landed symbol, removing the overlay symbol, and locking the respective cell;
in response to an overlay symbol of the second type and a newly landed symbol being co-located, removing the overlay symbol, transferring the value of the accumulator to the newly landed symbol and locking the respective cell;
repositioning any remaining overlay symbols in the symbol array, wherein repositioning each respective overlay symbol comprises moving the overlay symbol in a predetermined direction to the next unlocked cell in the symbol array or removing the overlay symbol from the symbol array in the event there is no unoccupied cell in the predetermined direction;
in response to at least one first type of overlay symbol being removed from the symbol array, adjusting a value of the accumulator;
adding new overlay symbols to unlocked cells in the symbol array;
decrementing the spin counter; and
in response to the spin counter reaching zero or all positions in the symbol array being occupied by locked symbols, ending the game and awarding a prize.

12. The gaming machine of claim 11, wherein the symbol array is initially empty.

13. The gaming machine of claim 11, wherein the overlay symbols are semi-transparent.

14. The gaming machine of claim 11, wherein placing the overlay symbols and adding new overlay symbols comprises randomly displaying the overlay symbols in unlocked cells of the symbol array.

15. The gaming machine of claim 11, wherein the game-logic circuitry is further configured to reset the spin counter in response to a symbol and an overlay symbol being co-located.

16. The gaming machine of claim 11, wherein the value borne by at least one of the first type of overlay symbols is selected from the group consisting of a monetary amount, a credit amount, and a progressive award label.

17. The gaming machine of claim 11, wherein the value of the accumulator is initialized to a random value.

18. The gaming machine of claim 11, wherein adjusting the value of the accumulator comprises incrementing the value of the accumulator by the value borne by the at least one first type of overlay symbol being removed from the symbol array.

19. The gaming machine of claim 11, wherein repositioning each respective overlay symbol further comprises skipping over locked cells.

20. The gaming machine of claim 11, wherein the game-logic circuitry is further configured to modify the newly landed symbol to a visually distinct enhanced symbol in response to the value of the accumulator being transferred to the newly landed symbol.
